(19) United States
(12) Patent Application Publication
(10) Pub. No.: US 2010/0082591 A1
(43) Pub. Date: Apr. 1, 2010

(54) LOCATOR MANAGEMENT DEVICE, LOCATOR TERMINAL, LOSS PREVENTION SYSTEM, AND RECORDING MEDIUM THAT RECORDS LOCATOR MANAGEMENT PROGRAM

(75) Inventor: Takahiro KOBA, Kawasaki (JP)

Correspondence Address: Fujitsu Patent Center;C/O CPA Global, P.O. Box 52050, Minneapolis, MN, 55402, US

(73) Assignee: FUJITSU LIMITED, Kawasaki (JP)

(21) Appl. No.: 12/567,768

(22) Filed: Sep. 26, 2009

(30) Foreign Application Priority Data
Oct. 1, 2008 (JP) 2008-256131

(51) Int. Cl. G06F 17/30

(52) U.S. Cl. 707/706; 707/E17.108

(57) ABSTRACT

A locator management device include a search object locator specifying unit that receives specification of a search object locator terminal by a user; a location information request mail generating unit that generates a location information request mail as an e-mail that requests the search object locator terminal to transmit location information; an e-mail transmitting unit that transmits the location information request mail to the search object locator terminal; an e-mail receiving unit that receives, from the search object locator terminal, a location information response mail as an e-mail in response to the location information request mail that includes the location information of the search object locator; and a display processing unit that displays, on a display screen, a location of the search object locator terminal based on the location information of the search object locator terminal included in the location information response mail.

### CROSS-REFERENCE TO RELATED APPLICATIONS

This application is based upon and claims the benefit of priority of the prior Japanese Patent Application No. 2008-256131, filed on Oct. 1, 2008, the entire contents of which are incorporated by reference herein.

### BACKGROUND

There is a technique for preventing the loss of articles by outputting a sound or emitting light from a small-sized informing device attached to an article, such as a car key, a house key, and a TV remote controller, which may often be lost. The small-sized informing device attached to the article as a loss prevention object is called a locator. The locator emits a sound or a light in response to a signal of infrared rays, a weak radio wave, or the like emitted from a device that has a function for calling the locator.

In a technique for preventing the loss of articles, for example, an informing device, attached to an article, transmits a weak radio wave if a button provided in a transmitter is pressed, and then the informing device that received the weak radio wave outputs a sound or emits a light. There is another technique for preventing loss of articles where a detector transmits an inquiry radio wave that includes an identifier and then receives a response radio wave from a terminal corresponding to the identifier. There is another technique for preventing loss of accessories by providing the accessory itself with a communication function.

### SUMMARY

According to an aspect of the invention, a locator management device that manages a locator terminal having a communication function includes a search object locator specifying unit that receives specification of a search object locator terminal by a user; a location information request mail generating unit that generates a location information request mail as an e-mail that requests the search object locator terminal to transmit location information; an e-mail transmitting unit that transmits the location information request mail to the search object locator terminal; an e-mail receiving unit that receives, from the search object locator terminal, a location information response mail as an e-mail in response to the location information request mail that includes the location information of the search object locator; and a display processing unit that displays, on a display screen, a location of the search object locator terminal based on the location information of the search object locator terminal included in the location information response mail.

The objects and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a diagram illustrating an overview of a loss prevention system according to the present embodiment,

FIG. 2 is a diagram illustrating a configuration example of a locator management device and a locator terminal according to the present embodiment,

FIG. 3 is a diagram illustrating a data configuration example of locator management information according to the present embodiment,

FIG. 4 is a diagram illustrating a data configuration example of setting information according to the present embodiment,

FIG. 5A to 5C is a diagram illustrating an example of searching for the locator terminal according to the loss prevention system of the present embodiment,

FIG. 6A to 6C is a diagram illustrating an example of loss prevention of a loss prevention object according to the loss prevention system of the present embodiment,

FIG. 7 is a locator search processing flowchart according to the locator management device of the present embodiment,

FIG. 8 is an infrared ray search processing flowchart according to the locator management device of the present embodiment,

FIG. 9 is a location information request mail response processing flowchart according to the locator terminal of the present embodiment,

FIG. 10 is a telephone incoming call response processing flowchart according to the locator terminal of the present embodiment,

FIG. 11 is an infrared ray search response processing flowchart according to the locator terminal of the present embodiment,

FIG. 12 is a locator location display processing flowchart according to the locator management device of the present embodiment,

FIG. 13 is a locator location automatic notification processing flowchart according to the locator terminal of the present embodiment, and

FIG. 14 is a locator terminal distance informing processing flowchart according to the locator management device of the present embodiment.

### DETAILED DESCRIPTION OF THE PREFERRED EMBODIMENTS

By using the diagrams, description will be made below of an embodiment of the present invention.

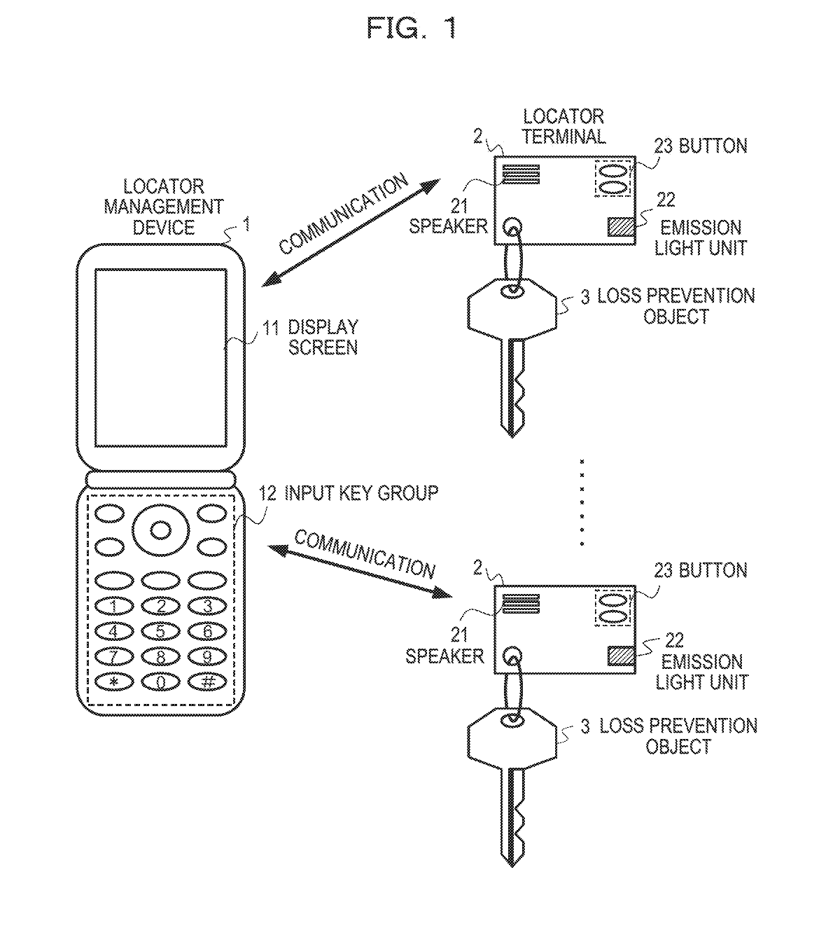

FIG. 1 is a diagram illustrating an overview of a loss prevention system according to the present embodiment. The loss prevention system according to the present embodiment includes a locator management device 1 and a single or a plurality of locator terminals 2.

In the present embodiment, the locator management device 1 manages a single or a plurality of locator terminals 2 and is realized by, for example, a mobile phone or a personal computer, and the like. In the example illustrated in FIG. 1, a mobile phone is the locator management device 1. The locator management device 1 includes a display function such as a display screen 11 and an input function such as an input key group 12. Furthermore, the locator management device 1 includes a communication function (diagram omitted) for communicating by using a telephone network, infrared communication, and the like, a location information obtaining function (diagram omitted) such as a GPS, and an informing function (diagram omitted) of sound output, emission light, vibration, and the like.

The locator terminal 2 includes an informing function as a speaker 21 that outputs a sound, such as a warning sound and/or a melody, an emission light unit 22 as an LED and the like, and includes an input function as a button 23 used to perform various settings. Furthermore, the locator terminal 2 includes a communication function (diagram omitted) for communication using a telephone network, infrared communication, and the like, and a location information obtaining function (diagram omitted) such as a GPS. The locator terminal 2 is shaped like a keychain or a strap so that the locator terminal 2 is easily attached to a loss prevention object 3.

The loss prevention object 3 to which the locator terminal 2 is attached is an article, for example, a car key, a house key, a bicycle key, a remote controller, and the like that a user does not want to lose. The loss prevention object 3 may be a human being. For example, to prevent lost children, a young child may carry the locator terminal 2.

The locator management device 1 and the locator terminal 2 may communicate with each other by using the communication functions provided in the locator management device 1 and the locator terminal 2. By communicating with the locator terminal 2, the locator management device 1 may make the locator terminal 2 emit sound or light and may obtain location information of the locator terminal 2.

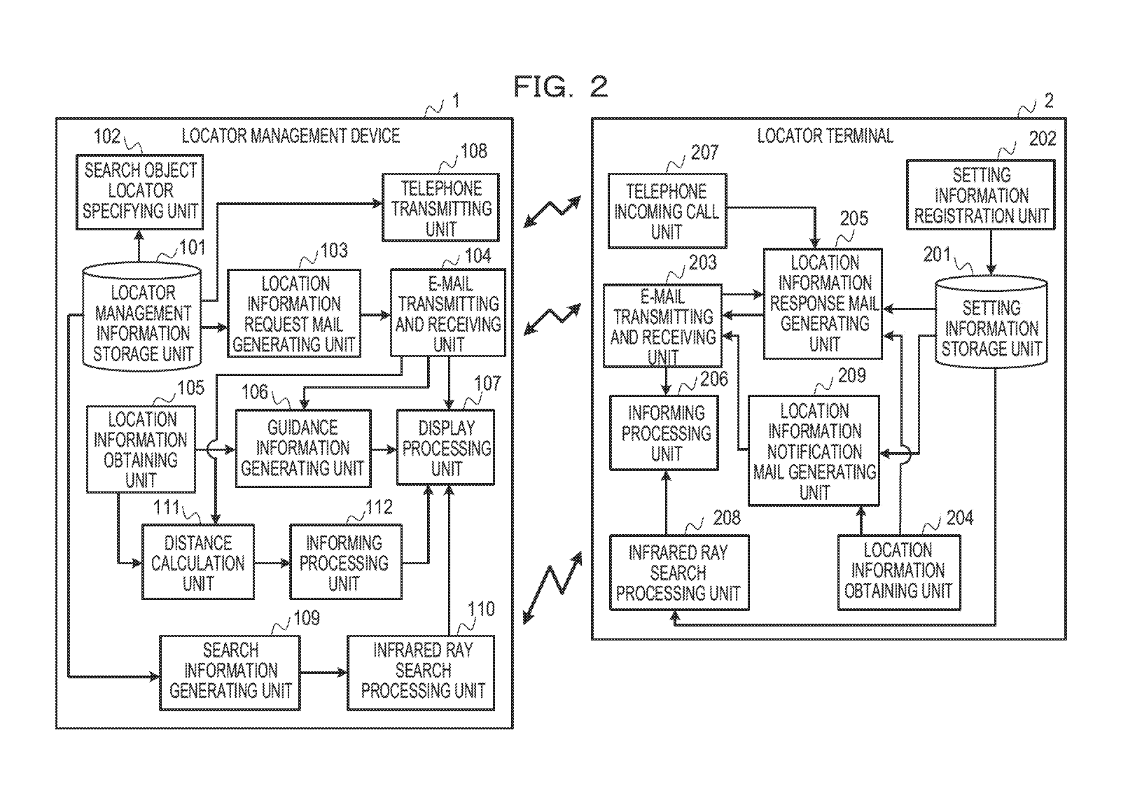

FIG. 2 is a diagram illustrating a configuration example of a locator management device and a locator terminal according to the present embodiment.

The locator management device 1 includes a CPU provided in a computer of the locator management device 1, a locator management information storage unit 101 that is achieved by hardware such as a memory and by a software program, a search object locator specifying unit 102, a location information request mail generating unit 103, an e-mail transmitting and receiving unit 104, a location information obtaining unit 105, an guidance information generating unit 106, a display processing unit 107, a telephone transmitting unit 108, a search information generating unit 109, an infrared ray search processing unit 110, a distance calculation unit 111, and an informing processing unit 112.

The locator management information storage unit 101 stores locator management information as management information of each locator terminal 2 managed by the locator management device 1.

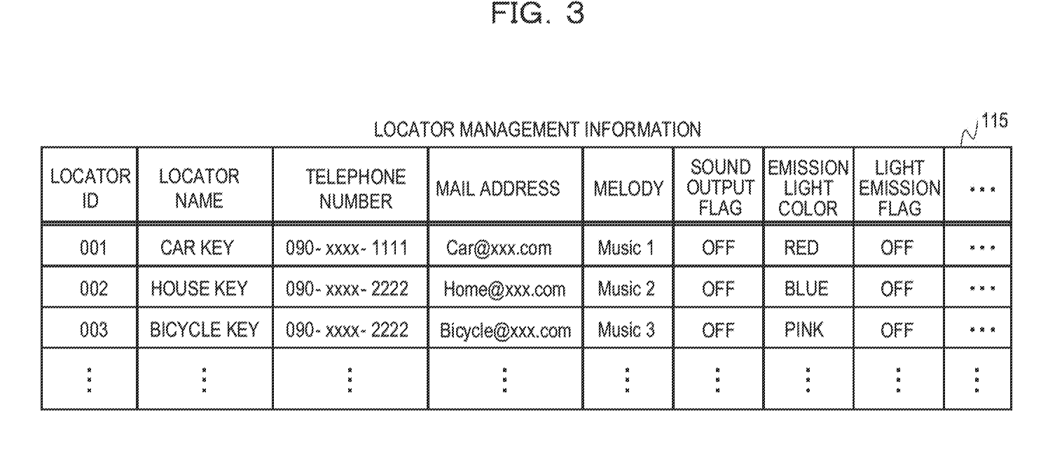

FIG. 3 is a diagram illustrating a data configuration example of locator management information according to the present embodiment. The locator management information 115 illustrated in FIG. 3 includes information such as a locator ID, a locator name, a telephone number, a mail address, a melody, a sound output flag, an emission light color, a light emission flag, and the like.

The locator ID is an identifier that uniquely identifies each locator terminal 2. The locator name is a name used by a user to easily recognize each locator terminal 2. The telephone number is the telephone number of the locator terminal 2. The mail address is the mail address of the locator terminal 2. The melody is a melody that is output from the locator terminal 2. The sound output flag is default-set to specify whether or not sound is output from the locator terminal 2 when the location information of the locator terminal 2 is requested by an e-mail. The emission light color is a color of the light emitted from the locator terminal 2. The emission light flag is a default-set to specify whether or not light is emitted from the locator terminal 2 when the location information of the locator terminal 2 is requested by an e-mail.

This information is registered or updated by user input using, for example, the input key group 12, or by communication with the locator terminal 2 using infrared communication, an e-mail, a USB cable, or the like.

In FIG. 2, the locator terminal 2 includes a CPU provided in a computer of the locator terminal 2, a setting information storage unit 201 that is achieved by hardware, such as a memory, and a software program, a setting information registration unit 202, an e-mail transmission and reception unit 203, a location information obtaining unit 204, a location information response mail generating unit 205, an informing processing unit 206, a telephone incoming call unit 207, an infrared ray search processing unit 208, and a location information notification mail generating unit 209.

The setting information storage unit 201 stores various setting information of the locator terminal 2.

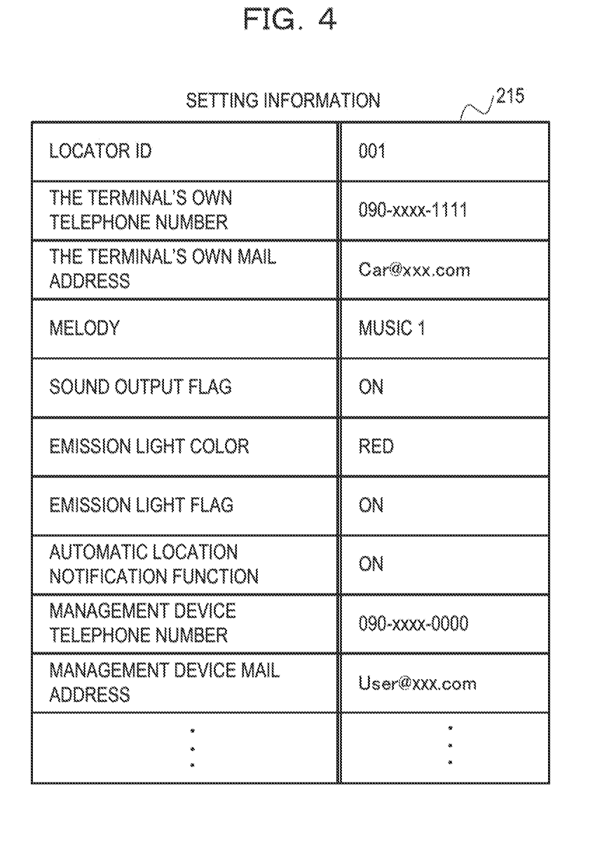

FIG. 4 is a diagram illustrating a data configuration example of setting information according to the present embodiment. The setting information 215 illustrated in FIG. 4 includes a locator ID, the terminal's own telephone number, the terminal's own mail address, a melody, a sound output flag, an emission light color, an emission light flag, an automatic location notification function, a management device telephone number, a management device mail address, and the like.

The locator ID is an identifier that uniquely identifies the locator terminal 2. The terminal's own telephone number is the telephone number of the locator terminal 2 itself. The terminal's own mail address is the mail address of the locator terminal 2 itself. The melody is the melody that is output from the speaker 21 at the time of sound output. The sound output flag is set to indicate whether or not sound is output when the search using infrared communication is received. The emission light color is a color of the light emitted from the emission light unit 22 at the time of light emission. The emission light flag is set to indicate whether or not light is emitted when the search using infrared communication is received. If there is no request of the location information from the locator management device 1, the automatic location notification function is set to indicate whether or not to transmit the location information of the locator management device 1 itself to the locator management device 1 at a given timing automatically. The management device telephone number is the telephone number of the locator management device 1 that manages the locator management device 1 itself. The management device mail address is the mail address of the locator management device 1 that manages the locator management device 1 itself.

This information is registered or updated by the setting information registration unit 202 by a user's input using, for example, the button 23 and/or communication with the locator management device 1 by using infrared communication, an e-mail, a USB cable, or the like. The melody at the time of sound output and the emission light color at the time of light emission may be selected from the melodies and the emission light colors already provided in the locator terminal 2. Furthermore, the melody at the time of sound output may be obtained by the communication with the locator management device 1.

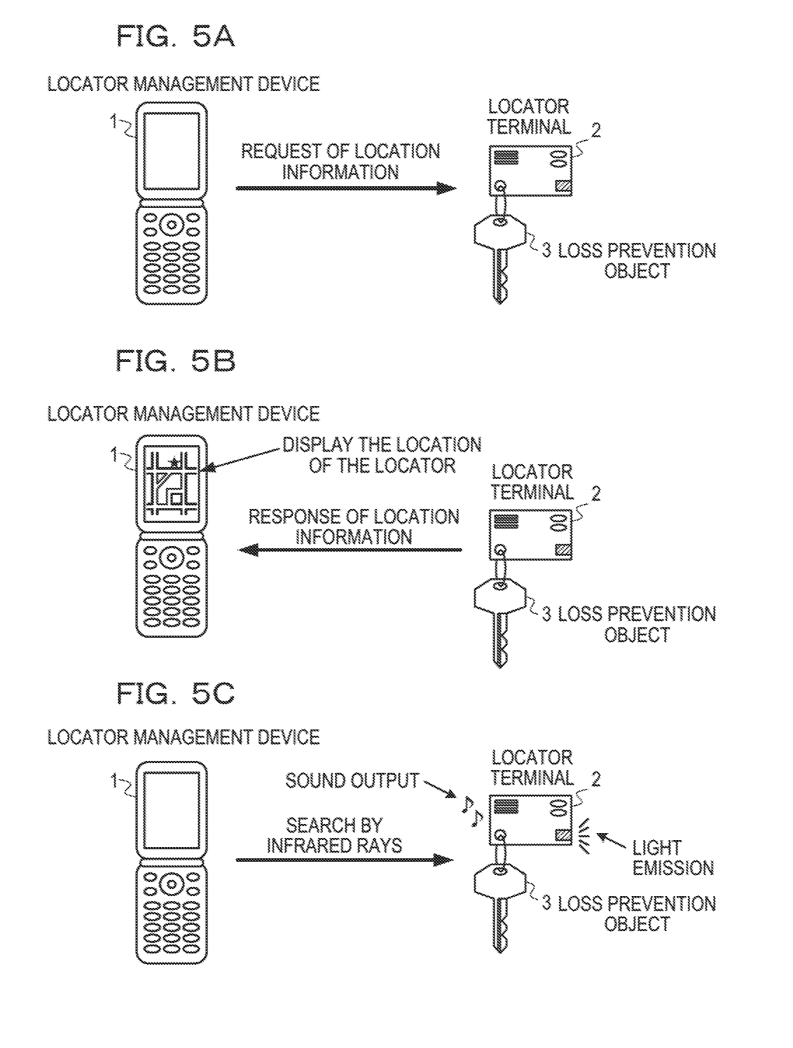

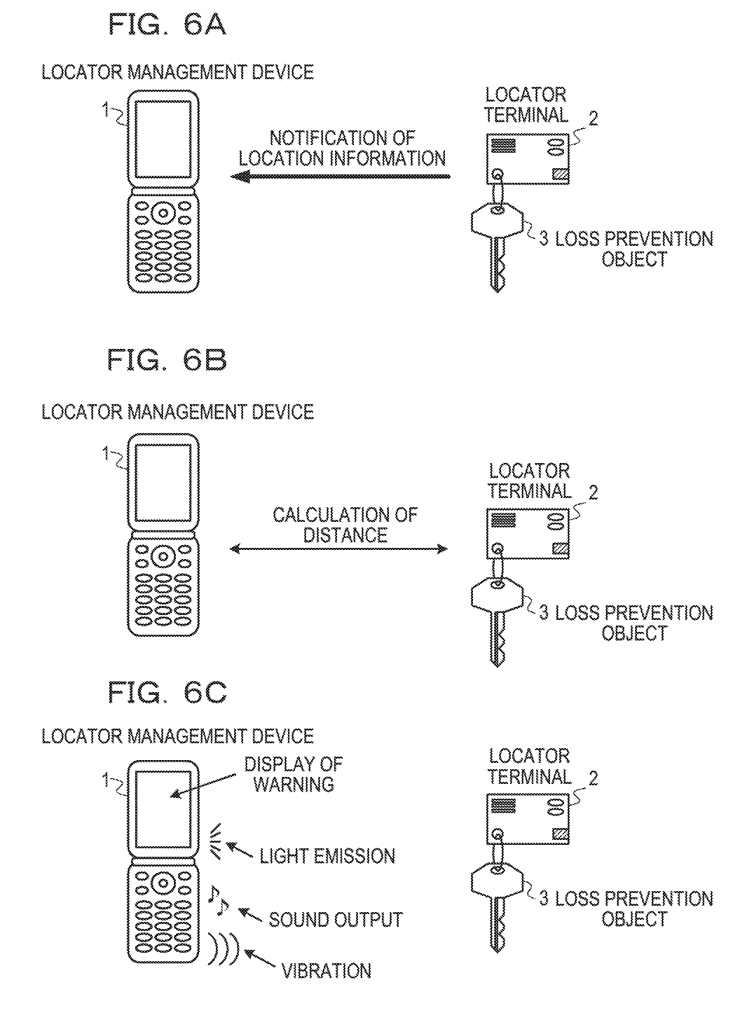

By using the specific examples illustrated in FIG. 5A to 5C and FIG. 6A to 6C, description will be made of operation examples of the locator management device 1 and the locator terminal 2 illustrated in FIG. 2.

FIG. 5A to 5C is a diagram illustrating an example of search of a locator terminal by a loss prevention system according to the present embodiment. The example illustrated in FIG. 5A to 5C is an example of a search for the locator terminal 2 in a case where, as a result of the search of the locator terminal 2 attached to a car key (the loss prevention object 3) performed by an infrared ray search from the locator management device 1, it is found that the locator terminal 2 is not present in an area near the locator management device 1 where the infrared rays may reach.

When the user calls the locator management function of the locator management device 1, the search object locator specifying unit 102 displays a list, on the display screen 11, of locator names of the locator terminals 2 registered in the locator management information 115 stored in the locator management information storage unit 101, and then receives selection of the locator terminal 2 as an object searched for by the user. In this case, the locator terminal 2 attached to a “car key” is specified as the locator terminal 2 to be a search object.

Here, the user is assumed to select the e-mail as a method of communication for searching for the locator terminal 2. At this time, the location information request mail generating unit 103 obtains a mail address of the locator terminal 2 as a search object from the locator management information 115, and then generates a location information request mail as an e-mail, which is in a given format for requesting the location information, addressed to the locator terminal 2 as the search object. In this case, a location information request mail whose destination mail address is “Car@xxx.com” is generated.

At this time, the location information request mail may include a specification of sound output or light emission and/or a specification of a melody of the sound output or a color of the emission light. For example, the search object locator specifying unit 102 asks the user to specify the use or non-use of the sound output or the emission light after the specification of the locator terminal 2 as the search object and the method of communication. If the user specifies the use of the sound output or the emission light, default setting of a melody, a sound output flag, an emission light color, and/or an emission light flag of the locator terminal 2 as the search object are displayed based on the locator management information 115. The user may change some of the settings if necessary. The location information request mail generating unit 103 includes the specified information concerning the sound output or the emission light in the location information request mail. The specification to be included in the location information request mail is only for the use or non-use of the sound output or the emission light. As for the melody, the sound output flag, the emission light, and the emission light flag, the specification of the setting information of the locator terminal 2 may be used.

In this manner, by specifying the sound output or the emission light by the location information request mail, for example, when a user goes home without knowing that he/she left behind the loss prevention object 3 in a friend's house and then makes his/her friend look for the loss prevention object 3, it is possible for the user to make the locator terminal 2, attached to the loss prevention object 3 left behind in the friend's house, output a sound or emit a light by remote control, so that the friend may find the loss prevention object 3.

As illustrated in FIG. 5A, the e-mail transmitting and receiving unit 104 of the locator management device 1 transmits a location information request mail that is addressed to the location terminal 2, and then the e-mail transmitting and receiving unit 203 of the locator terminal 2 receives the location information request mail.

If telephone is specified as a method of communication for searching for the locator terminal 2, the telephone transmitting unit 108 obtains the telephone number (“090-xxxx-1111” in this case) of the locator terminal 2 of the search object from the locator management information 115, and then performs telephone transmission to the locator terminal 2 as the search object.

Since the locator terminal 2 only needs to recognize an incoming call, one call of telephone transmission, for example, is applicable. If an incoming call is not received by the locator terminal 2, the request of the location information to the locator terminal 2 may be performed without charge.

When the locator terminal 2 confirms that the transmission source mail address of the location information request mail is the management device mail address registered in the setting information 215 stored in the setting information storage unit 201, the location information obtaining unit 204 obtains local information by a location information obtaining function provided in the locator terminal 2. If the telephone incoming call unit 207 receives an incoming call from the locator management device 1, the locator terminal 2 confirms that the incoming call telephone number is the management device telephone number registered in the setting information 215, and then the location information obtaining unit 204 obtains the location information.

The location information response mail generating unit 205 generates a location information response mail as an e-mail in a given format for responding to the location information. This location information response mail includes the obtained location information and is addressed to the locator management device 1 registered in the setting information 215. In this case, a location information response mail whose destination mail address is “User@xxx.com” is generated.

As illustrated in FIG. 5B, the e-mail transmitting and receiving unit 203 of the locator terminal 2 transmits a location information response mail addressed to the locator management device 1, and then the e-mail transmitting and receiving unit 104 of the locator management device 1 receives the location information response mail.

If the location information request mail from the locator management device 1 has specification of the use of the sound output or the emission light, the informing processing unit 206 outputs a melody from the speaker 21 or emits a light from the emission light unit 22 according to the specification.

In the locator management device 1, based on the location information of the locator terminal 2 as the search object included in the received location information response mail, the display processing unit 107 displays the location of the locator terminal 2 as the search object on the display screen 11. At this time, for example, by identifying the address based on the location information and displaying the address or by obtaining map information as illustrated in FIG. 5B, the location of the locator terminal 2 as the search object is displayed on a map displayed on the display screen 11.

Furthermore, the guidance from the locator management device 1 to the locator terminal 2 may be displayed. At this time, the location information obtaining unit 105 obtains the location information by a location information obtaining function provided in the locator management device 1. Based on the location information of the locator management device 1 and the location information of the locator terminal 2, the guidance information generating unit 106 generates guidance information from the locator management device 1 to the locator terminal 2. The user may receive the guidance to the locator terminal 2 as the search object by simply specifying the locator terminal 2 as the search object by the locator management device 1. Based on the generated guidance information, the display processing unit 107 displays the guidance, for example, a display of paths on the map of the display screen 11. The user may receive the guidance to the locator terminal 2 as the search object by simply specifying the locator terminal 2 as the search object by the locator management device 1.

The user moves to the location of the locator terminal 2 displayed on the display screen 11 and then performs a short distance search by using infrared communication.

The search information generating unit 109 obtains a locator ID of the locator terminal 2 as the search object from the locator management information 115 and then generates the search information that includes the locator ID. In this case, a locator ID “001” is obtained, and then the search information that includes the locator ID “001” is generated. As illustrated in FIG. 5C, the infrared ray search processing unit 110 of the locator management device 1 transmits the search information by infrared rays.

When receiving the search information by infrared rays, the infrared ray search processing unit 208 of the locator terminal 2 generates response information in response to the search information and transmits the response information by infrared rays if the locator ID included in the search information is the locator ID of the locator terminal 2 itself.

As illustrated in FIG. 5C, the informing processing unit 206 outputs a melody from the speaker 21 or emits a light from the emission light unit 22 according to the setting of the melody, the sound output flag, the emission light color, and the emission light flag of the setting information 215. In this case, the speaker 21 of the locator terminal 2 outputs a “Music 1,” and the emission light unit 22 emits the light in red (the emission light color “RED”).

The method of communication used for the search in the neighborhood of the locator management device 1 may use not only infrared rays but also, for example, weak radio waves.

As described above, the loss prevention system of the present embodiment may search for the loss prevention object 3 even though the located position of the loss prevention object 3 to which the locator terminal 2 is attached is not near the locator management device 1. This makes it possible to reduce if not prevent the loss of the loss prevention object 3. FIG. 6A to 6C is a diagram illustrating an example of loss prevention of the loss prevention object according to the loss prevention system of the present embodiment. The example illustrated in FIG. 6A to 6C is an example of misplacement prevention of the loss prevention object 3 in a case where the automatic location notification function is turned “ON” in the setting information 215 of the locator terminal 2.

In the locator terminal 2, the location information obtaining unit 204 obtains location information, at a given timing, for example, in 10 minute intervals, by the location information obtaining function provided in the locator terminal 2.

The location information notification mail generating unit 209 generates, at the given timing, a location information notification mail as an e-mail in a given format for informing the location information. The location information notification mail includes the obtained location information and the locator ID of the locator itself and is addressed to the locator management device 1 registered in the setting information 215.

As illustrated in FIG. 6A, the e-mail transmitting and receiving unit 203 of the locator terminal 2 transmits the location information notification mail addressed to the locator management device 1, and the e-mail transmitting and receiving unit 104 of the locator management device 1 receives the location information notification mail.

In the locator management device 1, the location information obtaining unit 105 obtains the location information by the location information obtaining function provided in the locator management device 1 if the locator ID included in the location information notification mail is the locator ID registered in the locator management information 115.

As illustrated in FIG. 6B, the distance calculation unit 111 calculates the distance between the locator management device 1 and the locator terminal 2 based on the obtained location information of the locator management device 1 and the location information of the locator terminal 2 included in the location information notification mail.

As illustrated in FIG. 6C, if the calculated distance is longer than a given distance (for example, 50 m), by the notification functions provided in the locator management device 1 such as displaying a warning on the display screen 11, emitting a light from an emission part, outputting a sound, vibrating the main body, and the like, the informing processing unit 112 gives a user a warning indicating that the user is away from the loss prevention object 3.

In this manner, the loss prevention system of the present embodiment allows the user to quickly notice that the user left behind the loss prevention object 3 to which the locator terminal 2 is attached, so that loss of the loss prevention object 3 may be reduced if not prevented. Moreover, when a child carries the locator terminal 2, the child's parent having the locator management device 1 may quickly notice that the child is away from the parent. This may help to prevent the child from becoming lost or getting involved in an incident or an accident.

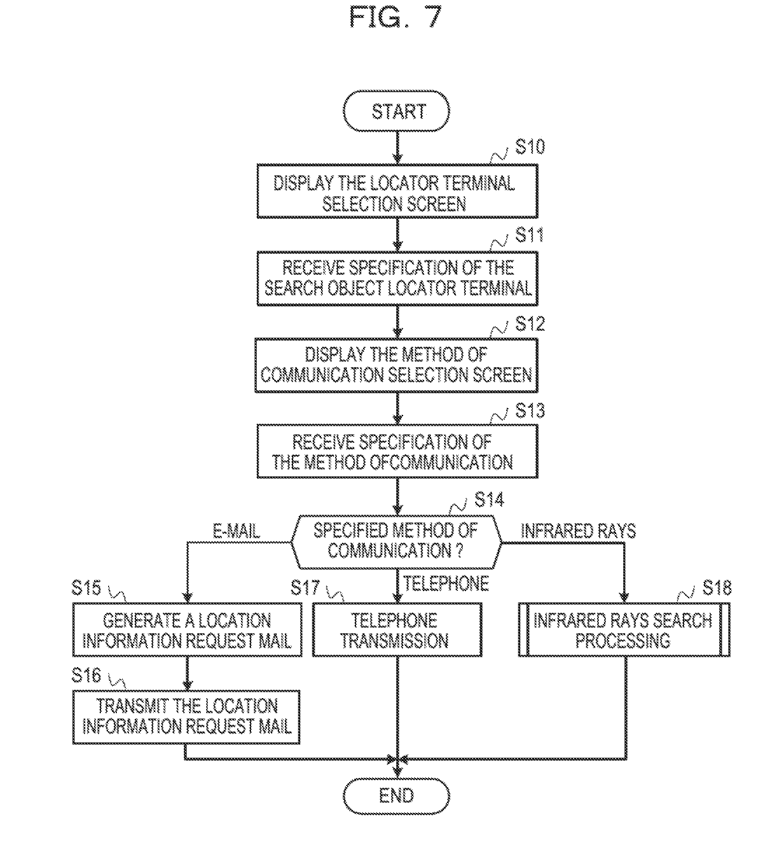

By using the flowcharts of FIG. 7 to FIG. 14, description will be made of a flow of the operation of the locator management device 1 and the locator terminal 2 according to the loss prevention system of the present embodiment.

FIG. 7 is a locator search processing flowchart according to the locator management device of the present embodiment.

When the user starts searching for the locator terminal 2, the locator management device 1 displays a selection screen of the locator terminals 2 to search for on the display screen 11 (step S10), and then receives specification of the locator terminal 2 as the search object from the user (step S11). Furthermore, the locator management device 1 displays the selection screen of the methods of communication on the display screen 11 (step S12), and then receives specification of the method of communication from the user (step S13).

If the specified method of communication is an e-mail (step S14), the locator management device 1 generates a location information request mail addressed to the locator terminal 2 as the search object (step S15), and then transmits the location information request mail by using the e-mail communication function provided in the locator management device 1 (step S16). At this time, the location information request mail may include the information for specifying the use or non-use of sound output and/or emission light. The location information request mail may include the locator ID of the locator terminal 2 as the search object.

If the specified method of communication is a telephone (step S14), the locator management device 1 performs telephone transmission to a telephone number of the locator terminal 2 as the search object by using a telephone communication function provided in the locator management device 1 (step S17).

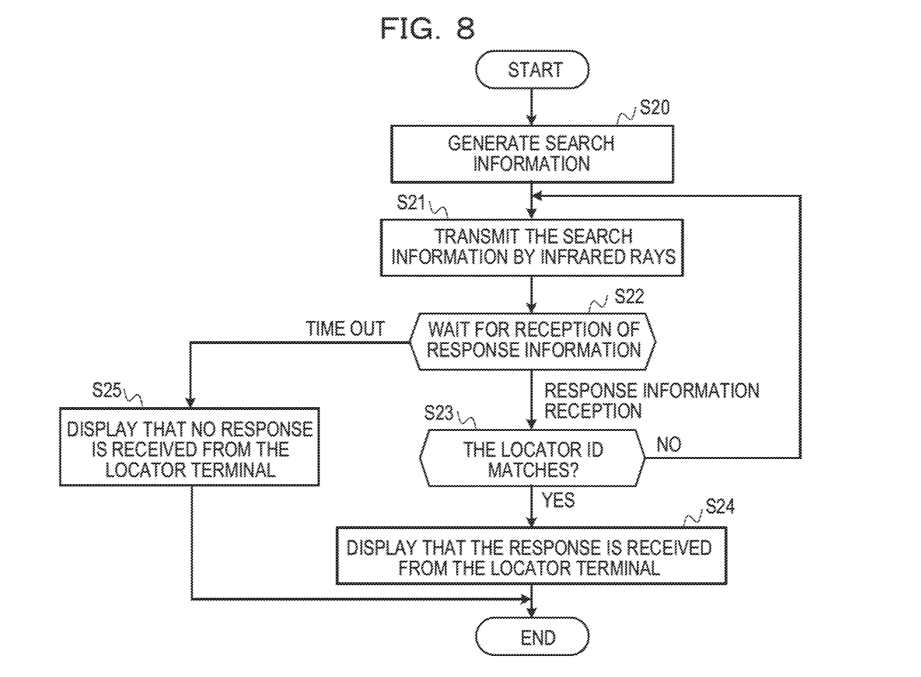

If the specified method of communication is infrared rays (step S14), the locator management device 1 performs infrared ray search processing illustrated in FIG. 8 (step S18).

FIG. 8 is an infrared ray search processing flowchart according to the locator management device of the present embodiment.

In step S14 of the flowchart illustrated in FIG. 7, if the specified method of communication is infrared rays, the locator management device 1 generates search information that includes the locator ID of the locator terminal 2 as the search object (step S20), and then emits the generated search information by using an infrared communication function provided in the locator management device 1 (step S21).

The locator management device 1 waits for reception of the response information from the locator terminal 2. When the response information is received (step S22), if the locator ID included in the received response information matches the locator ID included in the transmitted search information (step S23), the locator management device 1 displays, on the display screen 11, that the response is received from the locator terminal 2 as the search object (step S24).

The search information is transmitted by infrared rays repeatedly (step S21) until the response information in which the locator ID matches the locator ID included in the search information is received (step S23). When the reception standby of the response information times out (step S22), the locator management device 1 displays, on the display screen 11, that no response is received from the locator terminal 2 as the search object (step S25).

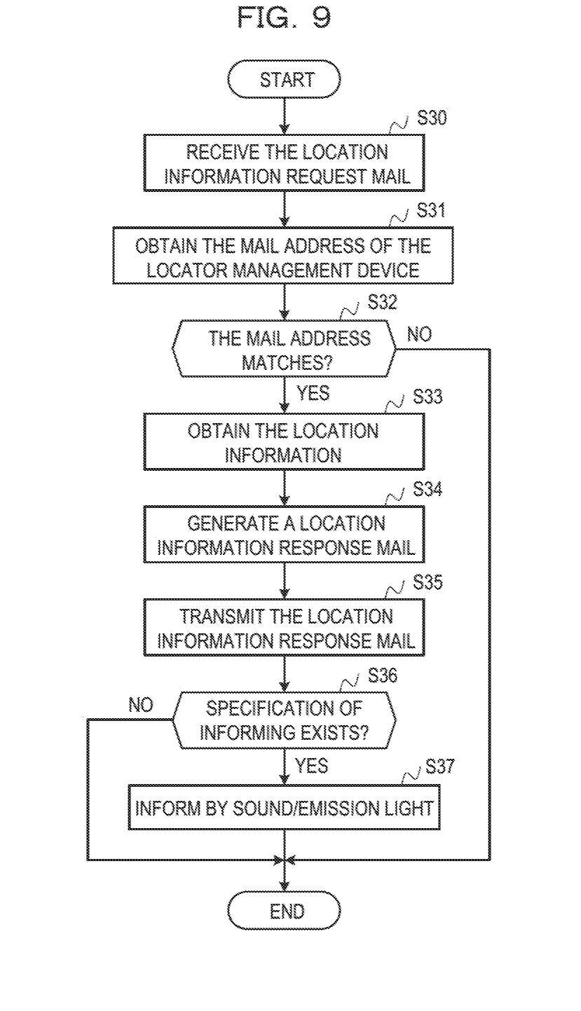

FIG. 9 is a location information request mail response processing flowchart according to the locator terminal of the present embodiment.

If the locator terminal 2 receives the location information request mail by the e-mail communication function provided in the locator terminal 2 (step S30), the locator terminal 2 obtains the mail address of the locator management device 1 registered in the setting information 215 (step S31). If the mail address of the locator management device 1 registered in the setting information 215 matches that of the transmission source of the location information request mail (step S32), the locator terminal 2 determines that the location information request mail is the location information request mail from the regular locator management device 1, and then continues the processing. At matching determination for the locator ID included in the location information request mail and the locator ID of the locator terminal itself, the locator terminal 2 may determine that the location information request mail is addressed to the locator terminal 2 itself.

By the location information obtaining function provided in the locator terminal 2, the locator terminal 2 obtains the location information of the locator terminal 2 itself (step S33), and then generates the location information response mail, addressed to the locator management device 1, that includes the obtained location information and the locator ID of the locator terminal 2 itself (step S34). The generated location information response mail is transmitted by using the e-mail communication function provided in the locator terminal 2 (step S35).

If the location information request mail from the locator management device 1 includes specification of informing by the sound output, the emission light, and/or the like (step S36), informing by sound and/or emission light is performed by the informing function provided in the locator terminal 2 (step S37).

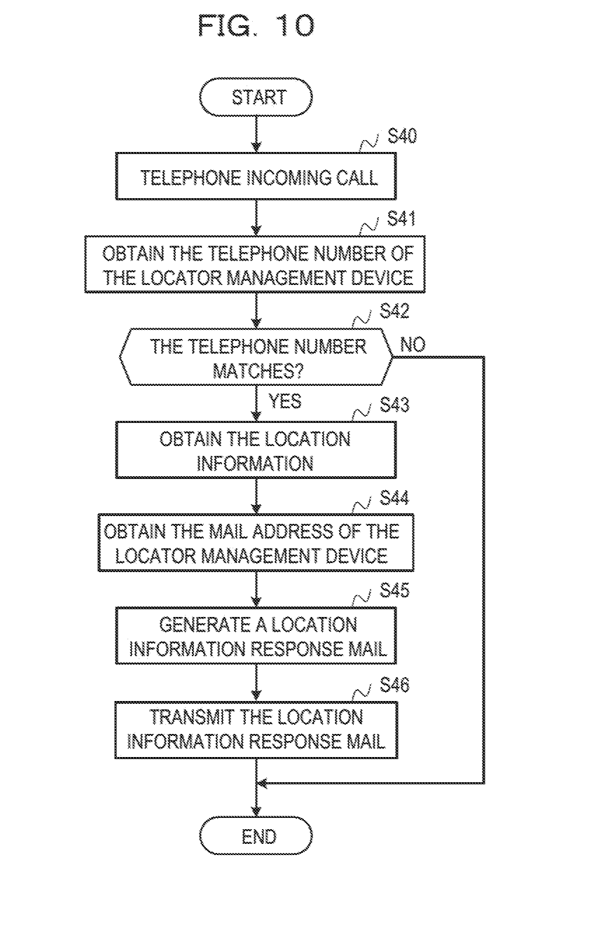

FIG. 10 is a telephone incoming call response processing flowchart of the locator terminal of the present embodiment.

If the locator terminal 2 confirms an incoming call by the telephone communication function provided in the locator terminal 2 (step S40), the locator terminal 2 obtains the telephone number of the locator management device 2 registered in the setting information 215 (step S41). If the telephone number of the locator management device 1 registered in the setting information 215 matches the incoming call telephone number (step S42), the locator terminal 2 determines that the incoming call is from the regular locator management device 1, and then continues the processing. The connection (picking up the receiver) of a telephone line is unnecessary if the incoming call telephone number is recognized.

The locator terminal 2 obtains the location information of the locator terminal 2 itself by the location information obtaining function provided in the locator terminal 2 (step S43). The locator terminal 2 obtains the mail address of the locator management device 1 registered in the setting information 215 (step S44). The locator terminal 2 generates a location information response mail, addressed to the locator management device 1, that includes the obtained location information and the locator ID of the locator terminal 2 itself (step S45), and then transmits the location information response mail by using the e-mail communication function provided in the locator terminal 2 (step S46).

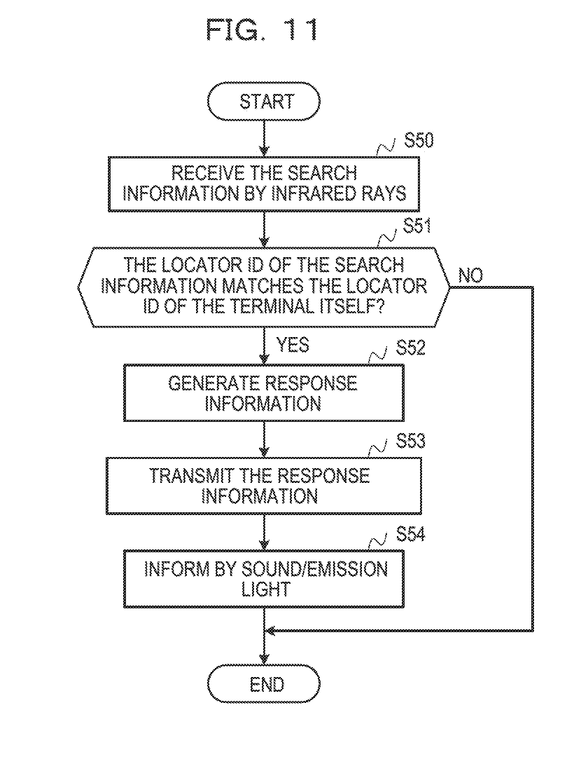

FIG. 11 is an infrared ray search response processing flowchart of the locator terminal of the present embodiment.

When the locator terminal 2 receives the search information by the infrared communication function provided in the locator terminal 2 (step S50), if the locator ID included in the search information matches the locator ID of the locator terminal 2 itself (step S51), the locator terminal 2 determines that the received search information is transmitted to the locator terminal 2 itself, and then continues the processing.

The locator terminal 2 generates response information that includes the locator ID of the locator terminal 2 itself (step S52), and then transmits the generated response information by infrared rays using the infrared communication function provided in the locator terminal 2 (step S53).

The locator terminal 2 performs informing by sound and/or emission light by the informing function provided in the locator terminal 2 (step S54).

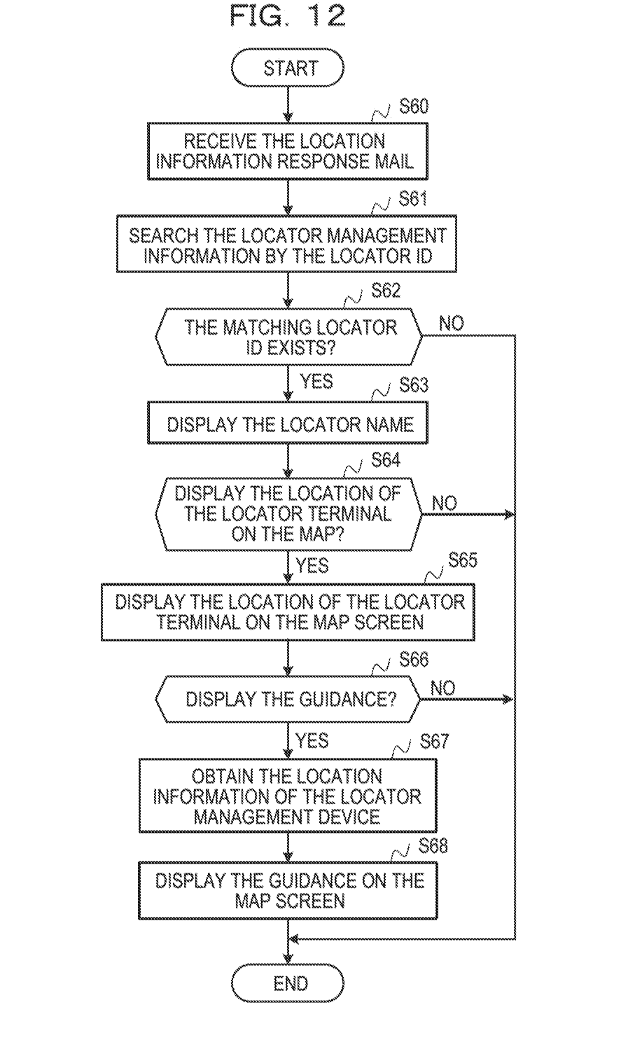

FIG. 12 is a locator location display processing flowchart of the locator management device of the present embodiment.

When receiving the location information response mail by the e-mail communication function provided in the locator management device 1 (step S60), the locator management device 1 searches the locator management information 115 by the locator ID included in the location information response mail (step S61).

If there is the matching locator ID (step S62), the locator management device 1 obtains a locator name corresponding to the locator ID from the locator management information 115 and then displays the locator name on the display screen 11 (step S63). At this time, the locator management device 1 may obtain an address corresponding to the location information of the locator terminal 2 included in the location information response mail and may display the address with the locator name.

The locator management device 1 asks the user whether or not to display the location of the locator terminal 2 on a map screen. If yes (step S64), the locator management device 1 obtains map information corresponding to the location information of the locator terminal 2 included in the location information response mail, displays the map information on the display screen 11, and displays the location of the locator terminal 2 on the displayed map screen (step S65).

The locator management device 1 asks the user whether or not to display the guidance to the locator terminal 2. If yes (step S66), the locator management device 1 obtains the location information of the locator management device 1 itself by the location information obtaining function provided in the locator management device 1 (step S67). Based on the obtained location information and the location information of the locator terminal 2, the locator management device 1 generates the guidance information from the locator management device 1 to the locator terminal 2 and displays the guidance on the map screen displayed on the display screen 11 (step S68).

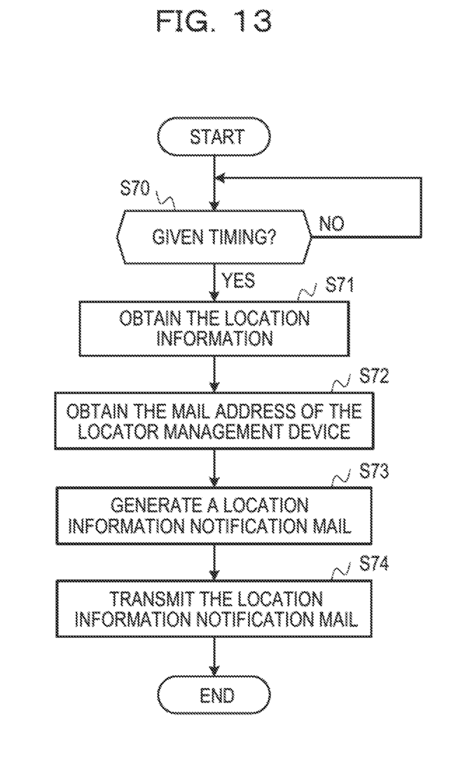

FIG. 13 is a locator location automatic notification processing flowchart of the locator terminal of the present embodiment.

The locator terminal 2, at a given timing (step S70), obtains the location information by the location information obtaining function provided in the locator terminal 2 (step S71). If the management device mail address (the mail address of the locator management device 1) is registered in the setting information 115, the locator terminal 2 obtains the mail address of the locator management device 1 (step S72).

The locator terminal 2 generates the location information notification mail, addressed to the locator management device 1, that includes the obtained location information and the locator ID of the locator terminal 2 itself (step S73), and then transmits the location information notification mail by using the e-mail communication function provided in the locator terminal 2 (step S74).

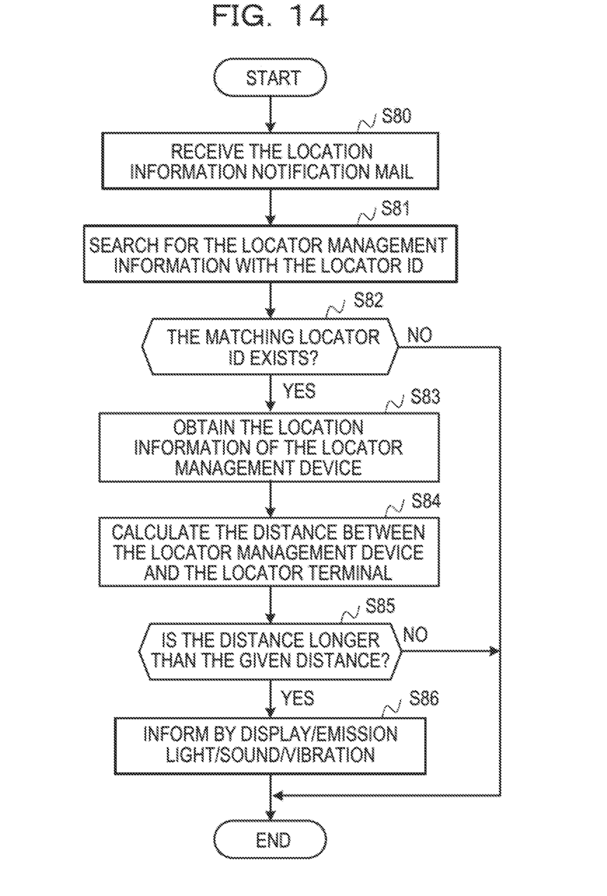

FIG. 14 is a locator terminal distance informing processing flowchart of the locator management device of the present embodiment.

When the locator management device 1 receives a location information notification mail by the e-mail communication function provided in the locator management device 1 (step S80), the locator management device 1 searches for the locator management information with the locator ID included in the location information notification mail (step S81). Determination of whether or not the received e-mail is the automatically transmitted location information notification mail may be performed by checking the header of the received e-mail after deciding that, for example, the information indicating the location information notification mail is to be written in the header of the received e-mail.

If there is the matching locator ID (step S82), the locator management device 1 obtains the location information of the locator management device 1 itself by the location information obtaining function provided in the locator management device 1 (step S83). Based on the obtained location information and the location information of the locator terminal 2 included in the location information notification mail, the distance between the locator management device 1 and the locator terminal 2 is calculated (step S84).

If the distance between the locator management device 1 and the locator device 2 is longer than a given distance (step S85), the locator management device 1 performs informing such as displaying a warning on the display screen 11, emitting a light from an emission part, outputting a sound, vibrating the main body, and the like by an informing function provided in the locator management device 1 (step S86).

Although the embodiment of the present invention has been described in detail, it should be understood that the various changes, substitutions, and alterations could be made hereto without departing from the spirit and scope of the invention.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A locator management device that manages a locator terminal having a communication function, the device comprising:
a search object locator specifying unit that receives specification of a search object locator terminal by a user,
a location information request mail generating unit that generates a location information request mail as an e-mail that requests the search object locator terminal to transmit location information,
an e-mail transmitting unit that transmits the location information request mail to the search object locator terminal,
an e-mail receiving unit that receives, from the search object locator terminal, a location information response mail as an e-mail in response to the location information request mail that includes the location information of the search object locator, and
a display processing unit that displays, on a display screen, a location of the search object locator terminal based on the location information of the search object locator terminal included in the location information response mail.

2. The locator management device according to claim 1, wherein the location information request mail includes information that specifies use or non-use of sound output or emission light by the locator terminal.

3. A locator management device that manages a locator terminal having a communication function, the device comprising:
a search object locator specifying unit that receives specification of a search object locator terminal by a user,
a telephone transmitting unit that transmits a call to the search object locator terminal,
an e-mail receiving unit that receives, from the search object locator terminal, a location information response mail as an e-mail in response to the telephone transmission, the e-mail including location information of the search object locator terminal, and
a display processing unit that displays, on a display screen, a location of the search object locator terminal based on location information of the search object locator terminal included in the location information response mail.

4. The locator management device according to claim 1, further comprising:
a location information obtaining unit that obtains location information of the locator management device itself, and
a guidance information generating unit that generates guidance information from the location of the locator management device itself to the location of the locator terminal based on the location information of the locator management device itself and the location information of the locator terminal,
wherein the display processing unit displays guidance by the guidance information on a display screen.

5. A locator management device that manages a locator terminal having a communication function, the device comprising:
an e-mail receiving unit that receives, from the locator terminal, a location information notification mail as an e-mail that includes location information of the locator terminal,
a location information obtaining unit that obtains the location information of the locator management device itself,
a distance calculation unit that calculates a distance from the location of the locator management device itself to the location of the locator terminal based on the location information of the locator management device itself and the location information of the locator terminal, and
an informing processing unit that informs that the calculated distance is longer than a given distance if the calculated distance is longer than the given distance.

6. A locator terminal that has a communication function, the terminal comprising:
an e-mail receiving unit that receives a location information request mail as an e-mail that requests location information from a locator management device that manages the locator terminal itself,
a location information obtaining unit that obtains the location information of the locator terminal itself,
a location information response mail generating unit that generates a location information response mail as an e-mail in response to the location information request mail that includes the location information of the locator terminal itself, and
an e-mail transmitting unit that transmits the location information response mail to the locator management device.

7. The locator terminal according to claim 6, further comprising:
an informing processing unit that performs informing by sound output or emission light according to specification information when the location information request mail includes the specification information that specifies use or non-use of the sound output or the emission light.

8. A locator terminal that has a communication function, the terminal comprising:
a telephone incoming call unit that confirms a telephone incoming call from a locator management device that manages the locator terminal itself,
a location information response mail generating unit that generates a location information response mail, as an e-mail in response to the telephone incoming call, the e-mail including location information of the locator terminal itself, and
an e-mail transmitting unit that transmits the location information response mail to the locator management device.

9. A locator terminal that has a communication function, the terminal comprising:
a location information obtaining unit that obtains location information of the locator terminal itself,
a location information notification mail generating unit that generates, at given time intervals, a location information notification mail as an e-mail that includes the location information of the locator terminal, and
an e-mail transmitting unit that transmits the location information notification mail to a locator management device that manages the locator terminal itself.

10. A loss prevention system that includes a locator terminal having a communication function and a locator management device that manages a locator terminal, wherein the locator management device comprises:
a search object locator specification unit that receives specification of a search object locator terminal by a user,
a location information request mail generating unit that generates a location information request mail as an e-mail that requests the search object locator terminal to transmit location information,
an e-mail transmitting unit that transmits the location information request mail to the search object locator terminal,
an e-mail receiving unit that receives, from the search object locator terminal, a location information response mail, as an e-mail in response to the location information request mail, that includes location information of the search object locator terminal,
a display processing unit that displays a location of the search object locator terminal on a display screen based on the location information of the search object locator terminal included in the location information response mail,
and wherein the locator terminal comprises:
an e-mail receiving unit that receives the location information request mail from the locator management device,
a location information obtaining unit that obtains the location information of the locator terminal,
a location information response mail generating unit that generates the location information response mail, and
an e-mail transmitting unit that transmits the location information response mail to the locator management device.

11. The loss prevention system according to claim 10, wherein the locator terminal includes an informing processing unit that informs by sound output or emission light according to the specification information when the location information request mail includes specification information that specifies use or non-use of the sound output or the emission light.

12. A loss prevention system that comprises a locator terminal having a communication function and a locator management device that manages the locator terminal, wherein the locator terminal comprises:
a location information obtaining unit that obtains location information of the locator terminal,
a location information notification mail generating unit that generates, at given intervals, a location information notification mail as an e-mail that includes location information of the locator terminal,
an e-mail transmitting unit that transmits the location information notification mail to the locator management device that manages the locator terminal,
and wherein the locator management device comprises:
an e-mail transmitting unit that receives the location information notification mail from the locator terminal,
a location information obtaining unit that obtains the location information of the locator management device,
a distance calculation unit that calculates a distance from the location of the locator management device to the location of the locator terminal based on the location information of the locator management device and the location information of the locator terminal, and
an informing processing unit that informs that the calculated distance is longer than a given distance if the calculated distance is longer than the given distance.

13. A computer-readable recording medium that records a program to be performed by a computer of a locator management device that manages a locator terminal having a communication function, the program making the computer to execute:
receiving specification of a search object locator terminal by a user,
generating a location information request mail as an e-mail that requests the search object locator terminal to transmit location information,
transmitting the location information request mail to the search object locator terminal,
receiving a location information response mail as an e-mail in response to the location information request mail, and
displaying a location of the search object locator on a display screen based on the location information of the search object locator terminal included in the location information response mail.
